(19) United States
(12) Patent Application Publication
(10) Pub. No.: US 2021/0216901 A1
(43) Pub. Date: Jul. 15, 2021

(54) ESTIMATION SYSTEM, ESTIMATION METHOD, AND ESTIMATION PROGRAM

(71) Applicants: KABUSHIKI KAISHA TOSHIBA, Tokyo (JP); TOSHIBA ENERGY SYSTEMS & SOLUTIONS CORPORATION, Kawasaki-shi, Kanagawa (JP)

(72) Inventors: Toshiya TAKANO, Sagamihara Kanagawa (JP); Kozo BANNO, Yokohama Kanagawa (JP); Tomohiro HOSHINO, Kotoku Tokyo (JP)

(73) Assignees: KABUSHIKI KAISHA TOSHIBA, Tokyo (JP); TOSHIBA ENERGY SYSTEMS & SOLUTIONS CORPORATION, Kawasaki-shi, Kanagawa (JP)

(21) Appl. No.: 15/734,077

(22) PCT Filed: Jun. 1, 2018
(86) PCT No.: PCT/JP2018/021194

§ 371 Date: Dec. 1, 2020

(51) Int. Cl. G06N 20/00; G06K 9/62

(52) U.S. Cl. CPC G06N 20/00; G06K 9/6226; G06K 9/6262

(57) ABSTRACT

An estimation model system, an estimation method, and an estimation program that can obtain an accuracy information for an estimation value is provided. The estimation system includes a learner 3 that creates an estimation model by machine learning from a correspondence relationship between a first input data and a first output data, an estimator 8 that estimates an output value obtained by inputting a data-for-estimation to the estimation model created by the learner 3 as a second estimation value which is an output value corresponding to the data-for-estimation, a precision estimation information creator 5 that acquires an accuracy reference information of a first estimation value obtained by inputting the first input data to the estimation model and creates a precision estimation information T which is a correspondence relationship between the first estimation value and the accuracy reference information, and a precision estimator 9 that acquires the accuracy reference information for the second estimation value based on the second estimation value and the precision estimation information T and acquires an accuracy information which is an estimation precision of the second estimation value based on the accuracy reference information for the second estimation value.

### FIELD

Embodiments of the present disclosure relate to an estimation system, an estimation method, and an estimation program.

### BACKGROUND

In recent years, machine learning is gathering attention as a construction scheme for estimation models. In particular, a neural network imitating a structure of cranial nerve system which is one of the machine learning can be non-linearly modeled, and since the neural network can accurately learn from the correspondence relationship between an input data and an output data corresponding to the input data as the material source, a modeling with high estimation precision can be expected.

Meanwhile, the estimation precision is dependent to data used at the time learning, and there is a problem that the estimation precision deteriorates when new input and output relationship which did not exist at the time of leaning occurs by the change in environment and condition.

### CITATION LIST

### Patent Literature

Patent Literature 1: WO2016/152053

### SUMMARY

If the estimation precision deteriorates by new input and output relationship that did not exist at the time of learning by the change in environment and condition as described above, it is considered to update the estimation model by making the neural network to learn from new input and output relationship as the material source. However, even when the difference between the estimation value by the estimation model and the actual value becomes large, if such a condition is only temporary, it can be said that the precision of the estimation model is not deteriorated, and updating the estimation model even in such a condition would be a big burden on the operator.

For this problem, an precision estimation system that can appropriately estimate the precision of the estimation model is invented, and this precision estimation system provides a system to estimate the precision of the estimation model for the deterioration of the estimation precision for the future value after predetermined time due to the change in environment and condition as the time elapse.

However, this precision estimation system estimates the precision of the estimation model from the actual value that would be obtained in the future after the estimation, and cannot obtain the precision and the accuracy of each estimation value of the estimation model, such that the precision estimation system cannot be applied to the field such as the operation of plant facilities and apparatuses which require reliability.

Embodiments of the present disclosure are made to address the above described problem, and the objective is to provide an estimation system, an estimation method, and an estimation program that can obtain a precision information for estimation values.

To achieve the above objective, an estimation system of the present disclosure includes:

a learner that creates an estimation model by machine learning from a correspondence relationship between a first input data and a first output data;

an estimator that estimates an output value obtained by inputting a second output data to the estimation model as a second estimation value which is an output value corresponding to the second input data;

a precision estimation information creator that acquires an accuracy reference information of a first estimation value obtained by inputting the first input data to the estimation model and creates a precision estimation information which is a correspondence relationship between the first estimation value and the accuracy reference information; and

a precision estimator that acquires the accuracy reference information for the second estimation value based on the second estimation value and the precision estimation information and acquires an accuracy information which is an estimation precision of the second estimation value based on the accuracy reference information for the second estimation value.

Furthermore, the present embodiment can be comprehended as a method to achieve the above process of each unit by a computer or an electronic circuit and a program to execute the above process of each unit by the computer.

That is, an estimation method of the present embodiment includes:

a learning process of creating an estimation model by machine learning from a correspondence relationship between a first input data and a first output data;

an estimating process of estimating an output value obtained by inputting a second output data to the estimation model as a second estimation value which is an output value corresponding to the second input data;

a precision estimation information creating process of creating a precision estimation information which is a correspondence relationship between the first estimation value obtained by inputting the first input data to the estimation model and an accuracy reference information for the first estimation value; and

a precision estimating process of acquiring the accuracy reference information for the second estimation value based on the second estimation value and the precision estimation information and acquiring an accuracy information for the second estimation value by outputting the accuracy reference information as the accuracy information that is an estimation precision of the second estimation value; and

an outputting process of outputting the second estimation value obtained by the estimating process and the accuracy information for the second estimation value obtained by the precision estimating process.

An estimation program of the present embodiment makes a computer to execute:

a learning process of creating an estimation model by machine learning from a correspondence relationship between a first input data and a first output data;

an estimating process of estimating an output value obtained by inputting a second output data to the estimation model as a second estimation value which is an output value corresponding to the second input data;

a precision estimation information creating process of acquiring an accuracy reference information of a first estimation value obtained by inputting the first input data to the estimation model and creating a precision estimation information which is a correspondence relationship between the first estimation value and the accuracy reference information; and

a precision estimating process of acquiring the accuracy reference information for the second estimation value based on the second estimation value and the precision estimation information and acquiring an accuracy information which is an estimation precision of the second estimation value based on the accuracy reference information for the second estimation value.

### BRIEF DESCRIPTION OF DRAWINGS

FIG. 1 is a diagram illustrating a configuration of an estimation system according to a first embodiment applied in a plant.

FIG. 2 is a block diagram of a precision estimation information creator.

FIG. 3 is a diagram for describing the precision estimation information creator.

FIG. 4 is a diagram illustrating about a creation of a frequency distribution.

FIG. 5 is a diagram sorting a range which the an estimation value can take and schematically illustrating the frequency distribution of teacher data value {b₁, b₂, . . . , b_{N}} for a section which each estimation value aᵢ (i=1, 2, . . . , N) belongs to.

FIG. 6 is a diagram illustrating an accuracy estimation information.

FIG. 7 is a flowchart illustrating a decision operation of an accuracy information for the estimation value in a precision estimator.

FIG. 8 is an operation flowchart to decide the decision of the accuracy information for the estimation value in a precision estimator by complementation.

FIG. 9 is a diagram illustrating a configuration of an estimation system according to a second embodiment applied in a plant.

FIG. 10 is a configuration of an estimation system according to a fourth embodiment applied in a plant.

### DETAILED DESCRIPTION

### First Embodiment

### (Standard Configuration)

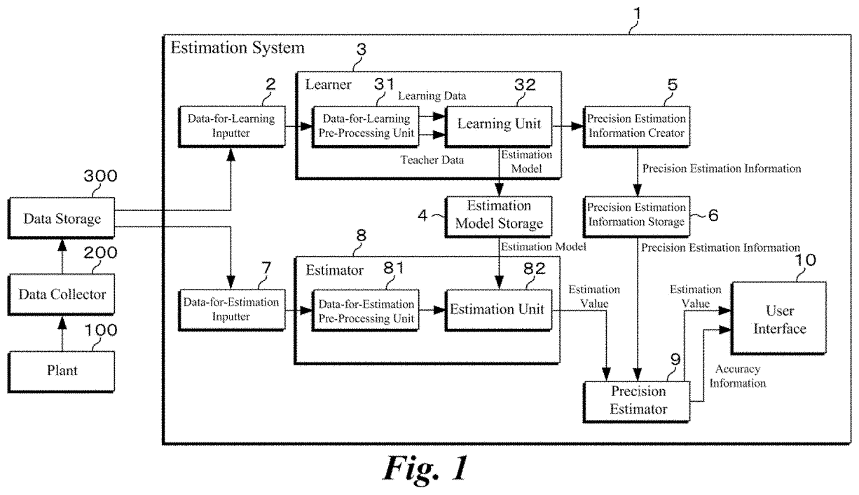

FIG. 1 is a diagram illustrating a configuration of an estimation system according to a first embodiment applied in a plant. As illustrated in FIG. 1, an estimation system 1 is connected to a plant 100 via a data collector 200 and a data storage 300.

The plant 100 is an assembly of facilities or apparatuses that generate input data and output data required for estimation. Aa the plant 100, for example, electrical systems and water supply facilities that require reliability and safety can be cited. The data collector 200 collects the input data to the facilities or the apparatuses of the plant 100 and the output data which is an output result therefrom by wireless or wired communication for every preset time interval, and stores the data in the data storage 300.

The data storage 300 associates and stores the input data and the output data for every preset time interval. Furthermore, the data storage 300 associates and stores an input data used in machine learning which would be described below (hereinafter referred to as a learning data) and an output data corresponding to the learning data (hereinafter referred to as a teacher data). These learning data and teacher data is past data of the plant 100 collected via the data collector 200.

The estimation system 1 creates an estimation model by performing the machine learning using the data stored in the data storage 300 and estimates the objective item according to this estimation model. Estimation items are, for example, a prediction value output from the facilities or the apparatuses of the plant 100 after predetermined time and an estimation of missing data which is data that had to be collected originally but was not collected due to failures in data transmission, etc.

The estimation system 1 includes and is constructed by single computer or a plurality of computers, and a display device. The estimation system 1 stores programs and databases in HDD and SSD etc., expands the programs and databases in RAM as appropriate, and processes them with CPU to performs calculation required for the creation of the estimation model and the creation of precision estimation information which would be described below.

In detail, the estimation system 1 includes a data-for-learning inputter 2, a learner 3, a estimation model storage 4, a precision estimation information creator 5, a precision estimation information storage 6, a data-for-estimation inputter 7, an estimator 8, a precision estimator 9, and a user interface 10.

The data-for-learning inputter 2 includes and is constructed by CPU and memories, and obtains and stores the learning data and the teacher data corresponding to the learning data from the data storage 30. Dimension numbers of the learning data and the teacher data are one dimension or more, and the number of records used in the learning may be set according to the number of obtained records and the estimation items.

The learner 3 includes and is constructed by CPU and memories, and creates the estimation model by machine learning from the correspondence relationship between the learning data and the teacher data obtained from the data-for-learning inputter 2. Various schemes such as a neural network, a decision tree, and a random forest may be used for the machine learning.

In the present embodiment, the learner 3 includes a data-for-learning pre-processing unit 31 and a learning unit 32. The data-for-learning pre-processing unit 31 includes and is constructed by CPU and memories, and inspects whether the learning data and the teacher data include failures such as missing or not, and if the failure is detected, the data-for-learning pre-processing unit 31 excludes the records of the learning data and the teacher data from the learning target. Furthermore, the data-for-learning pre-processing unit 31 may perform processing such as standardizing, for example, to average value: 0 and variance: 1, on the data-for-learning pre-processing unit 31 to efficiently create the estimation model.

The learning unit 32 includes and is constructed by CPU and memories, and creates the estimation model by machine learning based on the pre-processed learning data and the pre-processed teacher data obtained from the data-for-learning pre-processing unit 31. In the machine learning, parameters included in the estimation model is repeatedly adjusted so that a difference between an output of the estimation model (hereinafter referred to as an estimation value) and the teacher data would be minimum. For the adjustment of the parameters, for example, backpropagation may be used when the machine learning is the neural network.

The learner 3 completes the learning when the difference between the estimation value by the estimation model and the teacher data becomes equal to or less than the preset reference value, or when the repetition number of learning reaches the predetermined number, and outputs the created estimation model to the estimation model storage 4. Furthermore, the learner 3 outputs the teacher data which was used in the estimation model and the estimation value obtained when inputting the learning data corresponding to said teacher data to the precision estimation information creator 5.

The estimation model storage 4 includes and is constructed by memories and storages, and stores the estimation model created by the learner 3.

The precision estimation information creator 5 includes and is constructed by CPU and memories, and acquires an accuracy reference information of the estimation value obtained by inputting the learning data to the estimation model. This estimation value is a value output from the estimation model by inputting the learning data to said estimation model during the learning stage in the learner 3. This estimation value during the learning stage is referred to as a first estimation value in below. The accuracy reference information is an information the reference for the degree of accuracy of the estimation value, and for example, is standard deviation and variance. Furthermore, the precision estimation information creator 5 creates a precision estimation information that is a correspondence relationship between the estimation value obtained by inputting the learning data to the estimation model and the accuracy reference information relative to the estimation value. Details of this precision estimation information creator 5 would be described below.

The precision estimation information storage 6 includes and is constructed by memories and storages, and stores the precision estimation information created in the precision estimation information creator 5.

The data-for-estimation inputter 7 includes and is constructed by CPU and memories, and obtains and stores the input data that would be required for estimation (hereinafter referred to as a data for estimation) from the data storage 300 for the preset time interval. Then, the stored data for estimation is output to the estimator 8.

The estimator 8 includes and is constructed by CPU and memories, and estimates an output result by using the data for estimation and the estimation model. That is, the estimator 8 obtains the estimation model to use in the estimation from the estimation model storage 4. Then, the estimator 8 outputs the output value obtained by inputting the data for estimation to the estimation model as an estimation value that is the output value corresponding to the data for estimation. This estimation value corresponding to the data for estimation during the estimation stage by the estimator 8 is referred to as a second estimation value in below.

The estimator 8 of the present embodiment includes a data-for-estimation pre-processing unit 81 and an estimation unit 82. The data-for-estimation pre-processing unit 81 includes and is constructed by CPU, and inspects the presence of the failures such as missing for the data for estimation, and when the failures are detected, the data-for-estimation pre-processing unit 81 does not perform estimation and performs processing such as replacing by the previous estimation value. Furthermore, in the case the learning data and the teacher data in which the estimation model is standardized are created, the processing corresponding to the processing performed in the data-for-learning pre-processing unit 31 is performed. For example, when the standardizing process of average value: 0 and variance: 1 is performed for the learning data during learning, the standardizing is performed by using the average value and the variance of the learning data used at this time.

The estimation unit 82 includes and is constructed by CPU, and obtains the estimation model from the estimation model storage 4, inputs the pre-processed data for estimation output from the data-for-estimation pre-processing unit 81 to the estimation model, and outputs the estimation result to the precision estimator 9 as the estimation value.

The precision estimator 9 includes and is constructed by CPU, and acquires an accuracy information relative to the estimation value of the estimator 8. The accuracy information is an information indicating the degree of certainty relative to the estimation value of the estimator 8 (accuracy), and is acquired based on the accuracy reference information.

In detail, the precision estimator 9 obtains the precision estimation information from the precision estimation information storage 6, acquires the accuracy reference information for the second estimation value that is the estimation value at the estimation stage, and acquires the accuracy information that is the estimation precision of the estimation value of the estimation model by the estimator 8 based on the accuracy reference information. The precision estimator 9 outputs the acquired accuracy information and the estimation value corresponding to the accuracy information to the user interface 10. The details of the precision estimator is described later.

The user interface 10 outputs the estimation value obtained by the estimator 8 and the accuracy information for the said estimation value obtained by the precision estimator 9. Here, the estimation value obtained by the estimator 8 is the estimation value input from the precision estimator 9, however, may be the estimation value directly input from the estimator 8. The user interface 10 is, for example, a display device such as an organic EL and a liquid crystal display, and displays the estimation value obtained by the estimator 8 and the accuracy information for the said estimation value obtained by the precision estimator 9 as a pair of data. The user interface 10 may display a frequency distribution of the teacher data corresponding to the estimation value obtained by the estimator 8, other than the pair of data.

(Detailed Configuration)

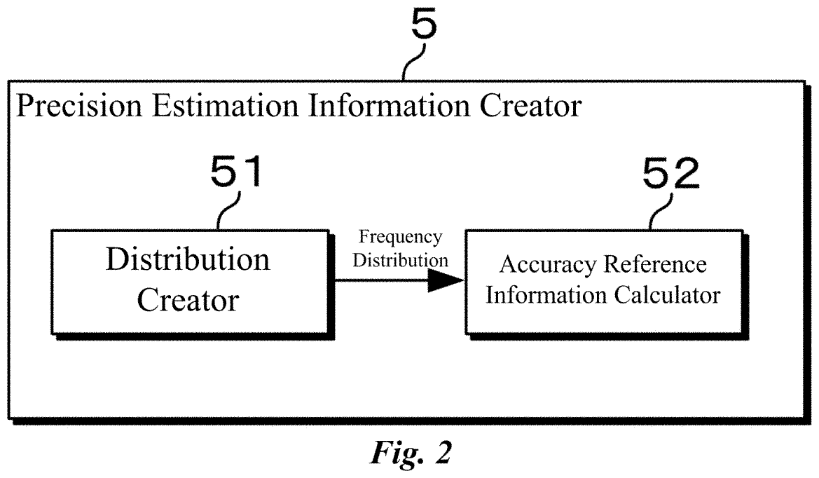

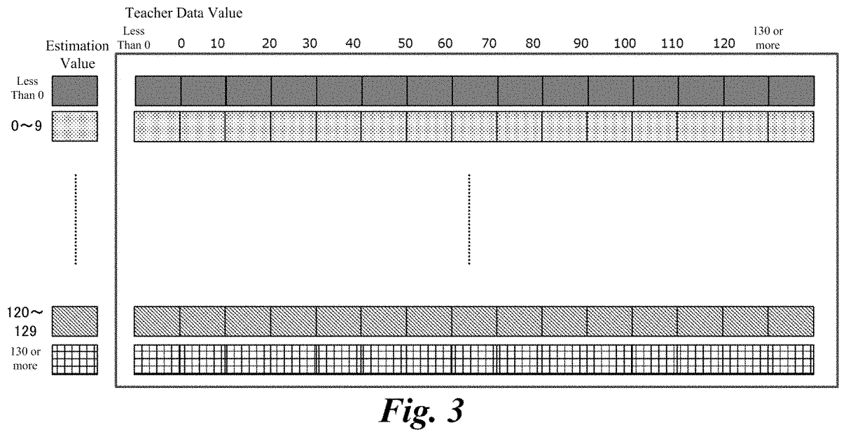

The precision estimation information creator 5 and the precision estimator 9 are further described in detail. FIG. 2 is a process block diagram of the precision estimation information creator 5. FIG. 3 is a diagram for describing precision estimation information creator 5. As illustrated in FIG. 2, the precision estimation information creator 5 includes a distribution creator 51 and an accuracy reference information calculator 52.

The distribution creator 51 includes and is constructed by CPU and memories, and as illustrated in FIG. 3, the distribution creator 51 divides ranges which the estimation value (the first estimation value) of the estimation model for the learning data may belong to, and associates the values of teacher data corresponding to said estimation value to the section to create the frequency distribution of the value of the teacher data corresponding to said estimation value for each section. Note that since the first estimation value is a value output by inputting the learning data to the estimation model, the first estimation value has a correspondence relationship with the learning data, and said learning data has a correspondence relationship with the teaching data. Therefore, the first estimation value and the teacher data, which both have correspondence with the same learning data, are in correspondence relationship.

In FIG. 3, the range to which the estimation value may belong is 0 to 129, and the example shows that the range is equally divided into 13 sections of 0 to 9, 10 to 19, 20 to 29, . . . , 120 to 129. In this example, when the estimation value is 85, said estimation value correspond to the range 80 to 89. In addition, when the estimation value is less than 0 or more than 130, they are regarded as the section of less than 0 or more than 130, respectively. Note that the to which the estimation value may belong are predetermined, for example, from the data specification of the facilities or the apparatuses of the plant 100.

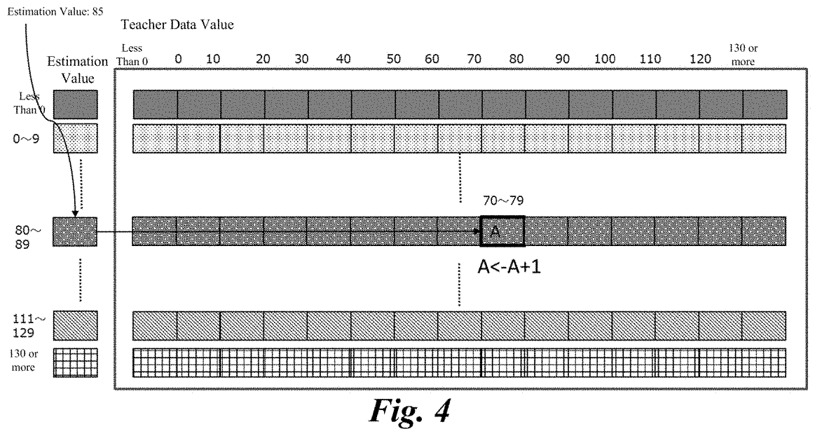

Regarding the correspondence relationship between the estimation value and the teacher data corresponding to the learning data, the distribution creator 51 records an accumulation information of the teacher data value to the corresponding section for each of the divided sections of the estimation value. For example, when the estimation value output by inputting the learning data to the estimation model is 85 and the teacher data corresponding to the estimation value is 79, the accumulation information A of the section 70 to 79 of the teacher data corresponding to the section 80 to 89 of the estimated range is updated to and is recorded as A+1. In other word, as illustrated in in FIG. 4, a value that is the accumulated information of the number of values of the teacher data corresponding to the estimation value is written into the square of each section of the teacher data value in the section of each estimation value.

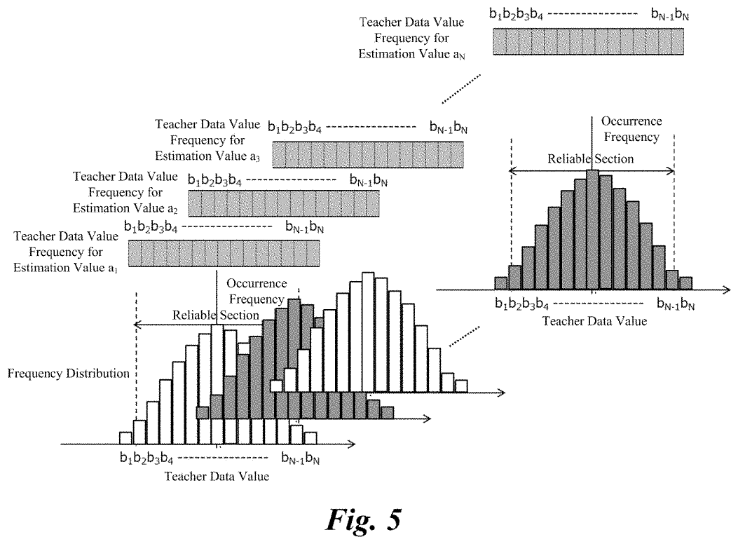

By this, the distribution creator 51 repeats the update of the accumulation information for the number of combination of the estimation value and the teacher data value corresponding to said estimation value to create the frequency distribution as illustrated in FIG. 5. FIG. 5 is a diagram sorting a range which the an estimation value may belong to and schematically illustrating the frequency distribution of the teacher data value {b₁, b₂, . . . , b_{N}} for a section which each estimation value aᵢ (i=1, 2, . . . , N) belongs to. The frequency distribution is a distribution in which the horizontal axis is the value of the teacher data and the vertical axis is the number of teacher data corresponding to the estimation value, and is created for sections of each estimation value. Note that N here is the number of the sections of the estimation value.

The accuracy reference information calculator 52 includes and is constructed by CPU, and calculates a standard deviation from the frequency distribution created by the distribution creator 51. That is, the accuracy reference information here is the standard deviation of the frequency distribution, and for example, the accuracy reference information calculator 52 calculates the standard deviation σ(aᵢ) (i=1, 2, . . . , N) from the frequency distribution according to Formula 1.

$$σ ( ai ) = \sqrt{\frac{{\sum }_{k = 1}^{L} {( {b}_{k} ( {a}_{i} ) - \overline{b} ( {a}_{i} ) )}^{2}}{L}} \qquad ( 1 )$$

bₖ(aᵢ) indicates the teacher data bₖ for the estimation value aᵢ. L indicates the number of the teacher data in the section to which the estimation value aᵢ belongs to.

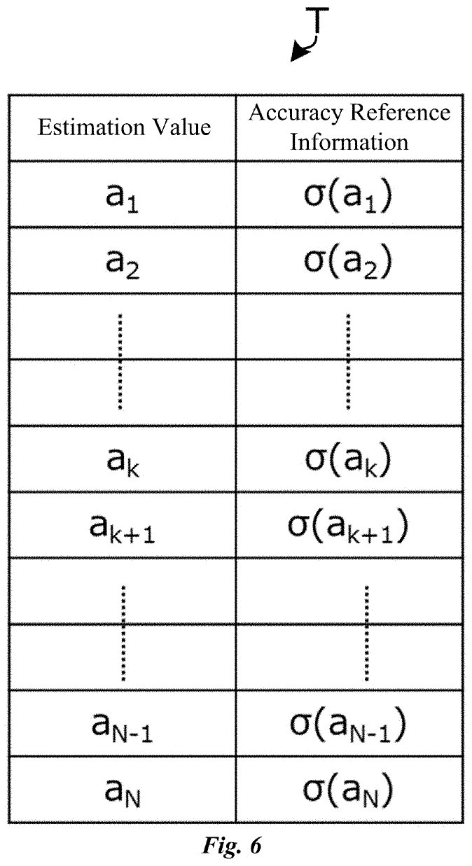

In this way, the precision estimation information creator 5 acquires respective accuracy reference information σ(aᵢ) (i=1, 2, . . . , N) for the estimation values aᵢ by the accuracy reference information calculator 52 and creates the precision estimation information T that is the correspondence relationship between the estimation value aᵢ and the accuracy reference information σ(aᵢ) for the estimation values aᵢ. For example, is a table that indicates the correspondence relationship between the estimation value aᵢ and the accuracy reference information σ(aᵢ) as illustrated in FIG. 6. Here, N is the number of sections of the estimation value. Therefore, the accuracy reference information σ(aᵢ) corresponds to the section to which the estimation value aᵢ and is acquired for the number of said sections (i=1, 2, . . . , N).

The precision estimator 9 refers the precision estimation information T from the precision estimation information storage 6, acquires the accuracy reference information corresponding to the estimation value input from the estimator 8, and acquires the accuracy information for said estimation value based on said accuracy reference information.

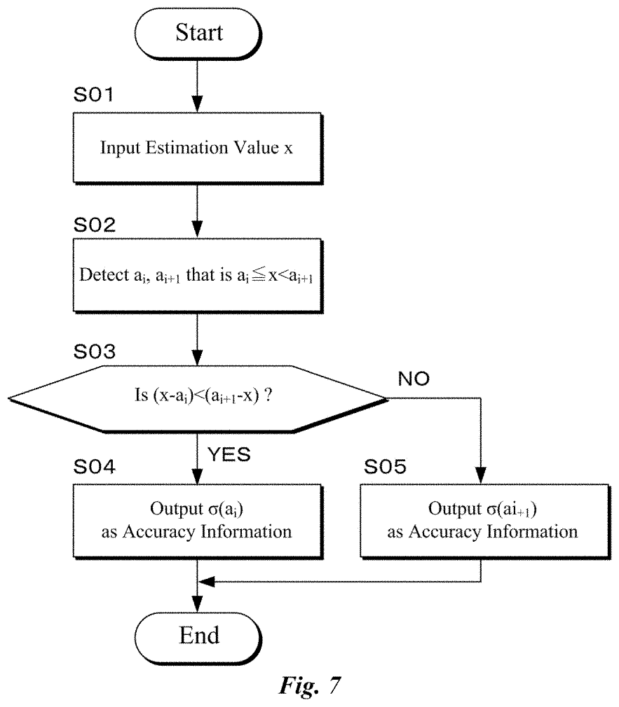

FIG. 7 is a flowchart illustrating a decision operation of the accuracy information for the estimation value in the precision estimator 9. As illustrated in FIG. 7, the precision estimator 9 receives the input of the estimation value x from the estimator 9 (step S01), and specifies the section to which the estimation value x belongs and detects aᵢ and aᵢ₊₁ in which aᵢ≤x<aᵢ₊₁ (step S02). Then, whether (x−aᵢ)<(aᵢ₊₁−x) is met or not is determined (step S03).

If (x−aᵢ)<(aᵢ₊₁−x) is met, (YES in step S03), The accuracy reference information σ(aᵢ) is output to the user interface 10 as the accuracy information (step S04). On the other hand, if (x−aᵢ)≥(aᵢ₊₁−x) (NO in step S03), σ(aᵢ₊₁) is output to the user interface 10 as the accuracy information (step S05).

Furthermore, although the accuracy estimator 9 output the accuracy reference information in which the estimation value x corresponds the estimation value that is the closest to the estimation value of the accuracy estimation information as the precision information as described above, the information obtained based on the complement of the accuracy reference information for the estimation value of the precision estimation information T may be output as the accuracy information as described below.

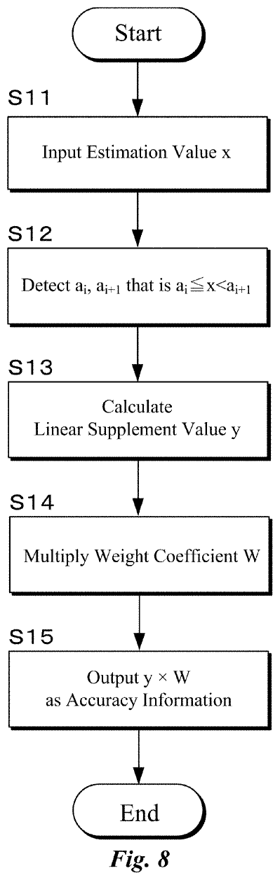

That is, as illustrated in FIG. 8, the precision estimator 9 receives the input of the estimation value x from the estimator 8 (step S11), and specifies the section to which the estimation value x belongs and detects aᵢ and aᵢ₊₁ in which aᵢ≤x<aᵢ₊₁ (step S12). Then, the accuracy reference information σ(aᵢ), σ(aᵢ₊₁) for the estimation value aᵢ and aᵢ₊₁, is searched from the precision estimation information T and a linear complement value y is calculated according to Formula (2) (step S13).

$$y = \frac{σ ( {a}_{i - 1} ) - σ ( {a}_{i} )}{{a}_{i - a} - {a}_{i}} x + \frac{{a}_{i - 1} σ ( {a}_{i} ) - {a}_{i} σ ( {a}_{i - 1} )}{{a}_{i - a} - {a}_{i}} \qquad ( 2 )$$

x in Formula (2) is the estimation value.

Furthermore, the precision estimator 9 multiplies the linear complement value y with a weight coefficient W (step S14), and the obtained value is output to the user interface 10 as the accuracy information (step S15). Note that the weight coefficient W is a real number and is preset. If parameters of data used when calculating the accuracy reference information σ(aᵢ), σ(aᵢ₊₁) is different in the section to which the estimation value aᵢ corresponding to the accuracy reference information σ(aᵢ) and the section to which the estimation value aᵢ₊₁ corresponding to the accuracy reference information σ(aᵢ₊₁), the weight coefficient W weighs the section which has the larger parameter to correct the linear complement value y.

(Action and Effect)

(1) The estimation system 1 of the present embodiment includes the learner 3 that creates the estimation model by machine learning from the correspondence relationship between the learning data and the teacher data, the estimator 8 that estimates the output value obtained by inputting the data for estimation to the estimation model created by the learner 3 as the second estimation value which is the output value corresponding to the data for estimation, the precision estimation information creator 5 that acquires the accuracy reference information of the first estimation value obtained by inputting the learning data to the estimation model and creates the precision estimation information T which is the correspondence relationship between the first estimation value and the accuracy reference information, and the precision estimator 9 that acquires the accuracy reference information for the second estimation value based on the second estimation value and the precision estimation information T and acquires the accuracy information which is the estimation precision of the second estimation value based on said accuracy reference information.

By this since the estimation value output from the estimation model created by machine learning and the accuracy information for said estimation value together, the accuracy for the estimation value can eb evaluated. Therefore, facilities and apparatuses of the plant that requires reliability and safety can be appropriately operated. For example, the estimation system 1 includes the user interface 10 that outputs the second estimation value obtained by the estimator 8 and the accuracy information for the second estimation value obtained by the precision estimator 9, so that the user can obtain the second estimation value and the accuracy information for said second estimation value and can evaluate the accuracy of the second estimation value.

(2) The precision estimation information creator 5 includes the distribution creator 51 that divides ranges to which the first estimation value of the estimation model may belong and associates the values of teacher data corresponding to the first estimation value to said section to create the frequency distribution of the value of the teacher data corresponding to the first estimation value for each said section, and the accuracy reference information calculator 52 that calculates the standard deviation from the frequency distribution.

By this, errors that are potentially included in the second estimation value can be estimated from the data used when the estimation model is created. That is, since examples of the learning data and the teacher data are used to create the estimation model, the errors included in the examples are reflected to the estimation model. Therefore, the first estimation value obtained by inputting the learning data to the estimation model may include the errors that are the difference between the first estimation data and the teacher data which is the actual value for the teacher data. Similarly, the second estimation value obtained by inputting the data for estimation to the estimation model may also include the errors, however, the errors potentially included in this second estimation value are considered to be the errors included in the examples used at the time of learning, that is, at the time of the creation of the estimation model. Therefore, the frequency distribution is created from the teacher data and the first estimation data used at the time of learning, and the standard deviation is calculated as the index to evaluate the errors, the accuracy of the second estimation value can be evaluated by referring to the standard deviation.

In this way, by acquiring the estimation value of the estimation model, the frequency distribution of the value of the teacher data corresponding to said estimation value, and the accuracy reference information obtained from the acquired frequency distribution a the time of learning the estimation model by machine learning, and acquiring the accuracy information based on the accuracy reference information at the time of estimation, the errors probabilistically included in the second estimation value can be given as the accuracy information, and the accuracy for the second estimation can be evaluated.

(3) The precision estimator 9 outputs the standard deviation (accuracy reference information) for the estimation value of the precision estimation information closest to the second estimation value as the accuracy information. By this, the accuracy information can be simply obtained.

(4) The precision estimator 9 outputs the value obtained by multiplying the linear complement value of the standard deviation (accuracy reference information) in the precision estimation information T including the second estimation value with the weight coefficient as the accuracy information. By this, the estimation accuracy for the estimation value of the accuracy information can be improved.

(5) The user interface 10 is a display device and displays the frequency distribution of the value of the teacher data for the first estimation value. By this, the user can check not only the estimation value and its accuracy information but also the frequency distribution, and can check if there is a deviation in the learning data from the shape of the frequency distribution. For example, when there is no deviation in the learning data and the learning is sufficient, the frequency distribution is expected to have a shape like normal distribution in which the average is at the center, and if the learning is precisely performed, the distribution becomes small and the shape of distribution is expected to become sharp.

### Second Embodiment

### (Configuration)

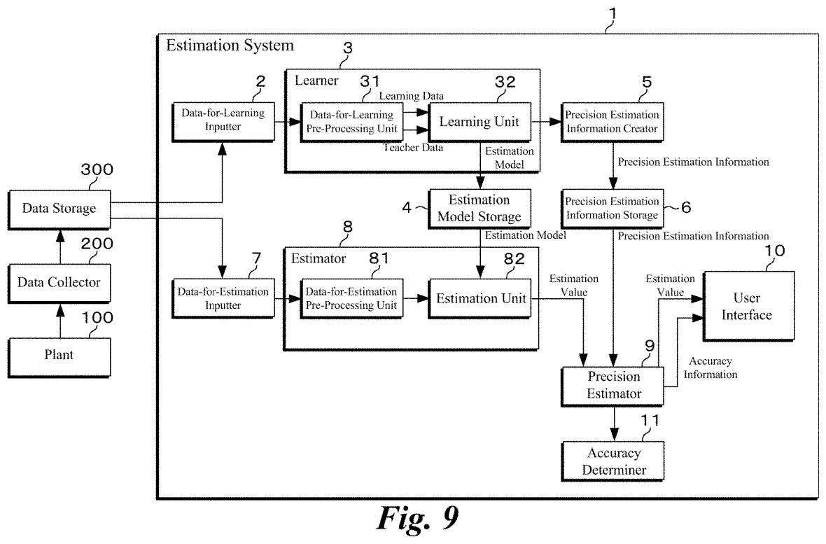

A second embodiment is described using FIG. 9. The second embodiment has the same basic structure as the first embodiment. In below, only the different points from the first embodiment are described, and the same reference signs are labeled to the same parts as the first embodiment and the detailed descriptions thereof are omitted.

FIG. 9 is a diagram illustrating a configuration of an estimation system according to a second embodiment applied in a plant. As illustrated in FIG. 9, the estimation system 1 includes an accuracy determiner 11.

The accuracy determiner 11 includes and is constructed by CPU, and provides a threshold for the accuracy information and determines whether the accuracy is lower than the threshold or not. In detail, the accuracy determiner 11 compares the threshold and the accuracy information output by the precision estimator, and when the accuracy information is lower than the threshold, creates an information indicating a section where the accuracy is determined as low and outputs the information indicating said section to the learner 3. Furthermore, the accuracy determiner 11 compares the threshold and the accuracy information, and when the accuracy information is equal to or more than the threshold, creates an information indicating a section where the accuracy is determined as high and outputs the information indicating said section to the learner 3.

Note that the accuracy determiner 11 specifies the section where the accuracy is determined as low or the section where the accuracy is determined as high as follows. Taking the section where the accuracy is determined as low as an example, since the accuracy information which was determined to be lower than the threshold has the corresponding second estimation value, the accuracy determiner 11 receives an input of said second estimation value from the precision estimator 9, also acquires the precision estimation information T from the precision estimator 9, and specifies the section to which said second estimation value belongs by referring the precision estimation information T.

Furthermore, the section where the accuracy is determined as low or the section where the accuracy is determined as high may be specified as follows. That is, since the precision estimator 9 specifies the section aᵢ to aᵢ₊₁ to which the second estimation value belongs by referring the precision estimation information T from the second estimation value, the accuracy determiner 11 obtains the section aᵢ to aᵢ₊₁ specified from the accuracy estimator 9. Meanwhile, since the accuracy determiner 11 determines whether the accuracy information is equal to or more than the threshold and the accuracy is high or the accuracy information is lower than the threshold and the accuracy is low by comparing the accuracy information obtained from the precision estimator 9 and the threshold, the accuracy determiner 11 specifies the section where the accuracy is high or the section where the accuracy is low by associating the said determination result and the obtained section aᵢ to aᵢ₊₁ based on the common second estimation value.

The learner 3 makes the estimation model to additionally learn by machine learning to update the estimation model. These new learning data and teacher data for the additional learning of the estimation model are the data-for-estimation which had low accuracy result and the actual value corresponding to the data-for-estimation which had low accuracy result that is produces after the creation of the estimation model. The data-for-estimation which had low accuracy result is the input data corresponding to the second estimation value used by the precision estimator 9 when acquiring the accuracy information determined as being lower than the threshold by the accuracy determiner 11. The actual value corresponding to the data-for-estimation which had low accuracy result that is produces after the creation of the estimation model is the output data value corresponding to the data-for-estimation which had low accuracy result among the output data value produced from the facilities and apparatuses of the plant 100 after the creation of the estimation model.

That is, the second estimation value of the estimator 8 is the prediction value after the predetermined time from the estimation, and in the case the actual value can be obtained after the predetermined time from the estimation, the data-for-estimation corresponding to said second estimation value which was determined to have low accuracy becomes the learning data, and the actual value after the predetermined time from the estimation becomes the teacher data. These learning data and the teacher data are the samples of the section where the accuracy is determined as low, and for example, are stores in the data-for-learning inputter 2. Note that the second estimation value which was determined to have low accuracy is the second estimation value corresponding to the accuracy information which was determined to have low accuracy by the accuracy estimator 11.

In this way, the learner 3 makes the estimation model to additionally learn by machine learning the material source which is the sample of the section where the accuracy is specified as low and which is newly produced after the creation of the estimation model, and updates the estimation model for the section where the accuracy is specified as low by the accuracy determiner 11.

Note that there is the second estimation value that corresponds to the accuracy information which was determined to have low accuracy by the accuracy estimator 11, and there is the data-for-estimation for said second estimation value. Therefore, the data-for-estimation which has low accuracy result can be specified. Furthermore, similarly, there is the second estimation value that corresponds to the accuracy information which was determined to have high accuracy by the accuracy estimator 11, and there is the data-for-estimation for said second estimation value. Therefore, the data-for-estimation which has high accuracy result can be specified.

For example, if the data-for-estimation Iⱼ is input to the estimator 8 and the second estimation value aⱼ is output from the estimator 8, the precision estimator 9 acquires the accuracy information Kⱼ corresponding to the obtained second estimation value aⱼ and output the accuracy information Kⱼ to the accuracy determiner 11. The accuracy determiner 11 determines high and low of the accuracy for the accuracy information Kⱼ by comparing the threshold for the obtained accuracy information Kⱼ. For example, the estimator 8 associates the data-for-estimation Iⱼ and the second estimation value aⱼ and stores them in the memory inside the estimation system 1, the precision estimator 9 associates the second estimation value aⱼ and the accuracy information Kⱼ and stores them in the memory inside the estimation system 1, and when the accuracy information Kⱼ is determined to have low accuracy, the accuracy determiner 11 takes out said accuracy information Kⱼ and the second estimation value aⱼ stored in the memory by the precision estimator 9 and takes out the data-for-estimation Iⱼ and the second estimation value aⱼ stored in the memory by the estimator 8 to specify the data-for-estimation Iⱼ corresponding to the accuracy information Kⱼ which was determined to have low accuracy.

Furthermore, the actual value bⱼ after the predetermined time from the estimation using said data-for-estimation Iⱼ is collected by the data collector 200 and is stored, for example, in the data-for-learning inputter 2 via the data storage 300. Therefore, by associating the data-for-estimation and the actual value after the predetermined time from the estimation, new sample for the additional learning for the section where the accuracy is determined as low can be obtained. For example, the estimator 8 associates the time tⱼ when the second estimation value aⱼ was estimated and the data-for-estimation Iⱼ corresponding to said second estimation value aⱼ and stores them in the memory inside the estimation system 1, and if the second estimation value aⱼ is the prediction value after the predetermined time Δt from the estimation time tⱼ, the accuracy determiner 11 obtains the actual value bⱼ produced at the time tⱼ+Δt from the data-for-learning inputter 2, and associates the specified data-for-estimation Iⱼ and the actual value bⱼ and stores them in the data-for-learning inputter 2.

(Action and Effect)

(1) The estimation system of the present embodiment includes the accuracy determiner 11 that provides the threshold for the accuracy information and determines whether the accuracy is high or low relative to the threshold. By this, the section where the accuracy is low can be found. That is, one cause for low accuracy may be few number of samples, and in the learning of the estimation model, the parameters included in the estimation model are merely adjusted so that the errors between the estimation value of the estimation model and the teacher data would be minimum, such that the section where the number of samples are insufficient is unknown, however, by the accuracy determiner 11, the section where it is estimated that the number of samples are insufficient can be known.

(2) The learner 3 updates the estimation model by making the estimation model to additionally learn by machine learning for the section where the accuracy was specified as low by the accuracy determiner 11. By this, the estimation accuracy for the estimation value at the section where the accuracy is low can be improved. In other words, since the high and low of the accuracy in each section is relative, by not performing the additional learning of the new samples consisting of the new input data and the actual value for said data in the section where the accuracy is high, the estimation accuracy for the estimation value at the section where the accuracy is low can be improved relatively to the estimation accuracy for the estimation value at the section where the accuracy is high.

Furthermore, by making the estimation model to additionally learn the new samples consisting of the new input data and the actual value for said data, the estimation accuracy for the new samples can be improved more than the estimation accuracy for the samples which was previously learned. That is, since the estimation accuracy for the new samples are emphasized and are reflected to the estimation model, the estimation model that follows the changes over time, etc. of the facilities and apparatuses of the plant 100 can be provided, and the estimation accuracy for the estimation target that changes the trend of output relative to the input can be improved.

### Third Embodiment

A third embodiment is described. The third embodiment has the same basic structure as the second embodiment. In below, only the different points from the second embodiment are described, and the same reference signs are labeled to the same parts as the second embodiment and the detailed descriptions thereof are omitted.

In the present embodiment, the learner 3 performs relearning and newly creates the estimation model. That is, the leaner 3 newly creates the estimation model by machine learning for the section where the accuracy was specified as low by the accuracy determiner from the correspondence relationship between the past learning data and teacher data which were used to create the estimation model and the correspondence relationship between the new learning data and teacher data after the creation of the estimation model.

In this way, the learner 3 performs relearning by machine learning and newly creates the estimation model for the section where the accuracy was specified as low by the accuracy determiner 11 from the correspondence relationship between the learning data and the teacher data and the correspondence relationship between the new learning data and the actual data corresponding to said data. By this, the estimation model that can perform precise estimation for the samples which are previously learned and for the samples that are newly learned can be achieved. In other words, the estimation model that can obtain the estimation value of high precision for all input can be achieved, and the reliability for the estimation can be improved.

### Fourth Embodiment

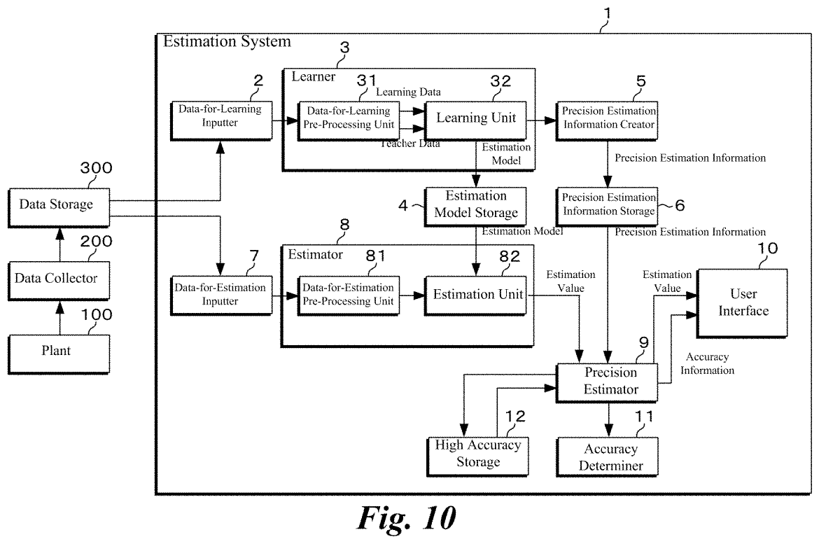

A fourth embodiment is described using FIG. 10. The fourth embodiment has the same basic structure as the second embodiment. In below, only the different points from the second embodiment are described, and the same reference signs are labeled to the same parts as the second embodiment and the detailed descriptions thereof are omitted.

FIG. 10 is a configuration of an estimation system according to a fourth embodiment applied in a plant. As illustrated in FIG. 10, the estimation system of the present embodiment includes a high accuracy storage 12.

The high accuracy storage 12 includes and is constructed by memories and storages, and associates and stores the second estimation value which was determined to have high accuracy and the time at which the estimator 8 had performed said estimation. Here, the second estimation value which was determined to have high accuracy is the estimation value which was used by the precision estimator 9 to acquire the accuracy information in the section which was specified to have high accuracy by the accuracy determiner 11.

When the estimated second estimation value is determined to have low accuracy by the accuracy estimator 11, the precision estimator 9 obtains the second estimation value which was determined to have high accuracy and which is the closest to the time of estimation, replaces the second estimation value which was determined to have low accuracy with the obtained second estimation value, and outputs the obtained second estimation value to the user interface 10.

For example, the precision estimator 9 associates the second estimation value which was determined to have high accuracy by the accuracy determiner 11 and the time at which said second estimation value was output by the estimator 8, and stores them in the high accuracy storage 12. Then, the other second estimation value estimated by the estimator 8 is output from the estimator 8, and when the obtained accuracy information is determined to have low accuracy by the accuracy determiner 11, the precision estimator 9 obtains the second estimation value at the time which is closest to and is before the time at which the above other second estimation value was estimated by the estimator 8, stored in the high accuracy storage 12. Then, the accuracy information is acquired according to the obtained second estimation value.

The estimation system of the present embodiment includes the high accuracy storage 12 that associates and stores the second estimation value which was determined to have high accuracy by the accuracy determiner 11 and the time at which the estimator 8 had performed said estimation, and when the estimated second estimation value is determined to have low accuracy by the accuracy estimator 11, the precision estimator 9 obtains the second estimation value which was determined to have high accuracy and which is the closest to the time of estimation from the high accuracy storage 12, replaces the second estimation value which was determined to have low accuracy with the obtained second estimation value, and outputs the obtained second estimation value to the user interface 10.

For example, in the case the estimation target is the control value to control the facilities and apparatuses of the plant, it is not preferable to use the estimation value which has low accuracy as the control value in the facilities and apparatuses of the plant which requires reliability. In contrast, by replacing the estimation value which has low accuracy with the estimation value which is the closest and which has high accuracy, it can be rapidly coped without performing additional learning and relearning even in the case in which the accuracy is determined as low. If the section where the accuracy is low is identified, since the additional learning and relearning is performed after certain number of new samples (actual values) are accumulated, the span for the accuracy to be corrected would be relatively long. In contrast, even when the accuracy is identified as low, if the accuracy is determined as high before said estimation, it can be rapid coped by using said estimation value for the section where the accuracy was determined as low.

### Other Embodiment

In the present specification, a plurality of embodiments according to the present invention are described, however, these embodiments are only presented as examples and are not intended to limit the scope of claims. Above embodiments may be implemented in other various forms, and various omissions, replacement, and modifications can be made without departing from the scope of invention. These embodiments and modifications thereof are included in the scope of invention and abstract, and are similarly included in invention described in the scope of claims and equivalent thereto.

Although the first to fourth embodiments include the user interface 10, they may not necessarily include the user interface 10. For example, the estimation system 1 may output the accuracy information acquired by the precision estimator 9 and the estimation value corresponding to said accuracy information to the outside, as necessary. Such an estimation system 1 is, for example, a server constructed by single or a plurality of computers.

Although the first to fourth embodiments perform pre-processing on the learning data, the teacher data, and the data-for-estimation by the data-for-learning pre-processing unit 31 and the data-for-estimation pre-processing unit 81, they may not necessarily be performed.

In the second and third embodiments, although the additional learning and relearning are performed for the section where the accuracy is low, the additional learning and relearning may be performed for the section where the accuracy is high. In this way, the estimation accuracy of the estimation value for the section where the accuracy is high can be further improved, and this estimation value can be used to appropriately operate the facilities and apparatuses of the plant which require reliability and safety.

In the first to fourth embodiments, although the accuracy reference information is the standard deviation of the frequency distribution, it may be a reliable section. That is, the accuracy reference information calculator 52 calculates the reliable section from the frequency distribution. The reliable section can be calculated by sample average±t×sample standard deviation/√(number of samples). t can be acquired from t frequency table and degree of freedom (=samples−1). For example, when the reliable section is a 99.7% reliable section, t=3. The precision estimation information creator 5 acquires the precision estimation information T that is the correspondence relationship between the estimation value and the acquired reliable section. Then, the precision estimator 9 acquires the reliable section corresponding to the estimation value from the estimation value and the precision estimation information T and acquires the accuracy information based on the reliable section. For example, the precision estimator 9 outputs |reliable section−sample average| as the accuracy information.

### REFERENCE SIGNS

1: estimation system
2: data-for-learning inputter
3: learner
31: data-for-learning pre-processing unit
32: learning unit
4: estimation model storage
5: precision estimation information creator
51: distribution creator
52: accuracy reference information calculator
6: precision estimation information storage
7: data-for-estimation inputter
8: estimator
81: data-for-estimation pre-processing unit
82: estimating unit
9: precision estimator
10: user interface
11: accuracy determiner
12: high accuracy storage
T: precision estimation information
100: plant
200: data collector
300: data storage

1. An estimation model comprising:
a learner that creates an estimation model by machine learning from a correspondence relationship between a first input data and a first output data;
an estimator that estimates an output value obtained by inputting a second output data to the estimation model as a second estimation value which is an output value corresponding to the second input data;
a precision estimation information creator that acquires an accuracy reference information of a first estimation value obtained by inputting the first input data to the estimation model and creates a precision estimation information which is a correspondence relationship between the first estimation value and the accuracy reference information; and
a precision estimator that acquires the accuracy reference information for the second estimation value based on the second estimation value and the precision estimation information and acquires an accuracy information which is an estimation precision of the second estimation value based on the accuracy reference information for the second estimation value.

2. The estimation system according to claim 1, wherein the precision estimation information creator comprises:
a distribution creator that divides ranges, which the first estimation value of the estimation model may belong to, to a section, associates the value of the first input data corresponding to the first estimation value to the section, and creates a frequency distribution of the value of the first input data corresponding to the first estimation value for each of the section, and
an accuracy reference information calculator that calculates a standard deviation from the frequency distribution as the accuracy reference information.

3. The estimation system according to claim 2, wherein the accuracy estimator outputs the standard deviation for the estimation value of the precision estimation information which is closest to the second estimation value as the accuracy information.

4. The estimation system according to claim 2, wherein outputs a value which is obtained by multiplying a linear complement value of the standard deviation for the estimation value in the precision estimation information including the second estimation value with a weight coefficient, as the accuracy information.

5. The estimation system according to claim 1, comprising a user interface that outputs the estimation value obtained by the estimator and the accuracy information for the second estimation value obtained by the precision estimator.

6. The estimation system according to claim 5, wherein the user interface is a display device and displays the frequency distribution of the value of the first output data for the first estimation value.

7. The estimation system according to claim 5, comprising an accuracy determiner provides a threshold for the accuracy information and determines whether the accuracy is lower than the threshold or not.

8. The estimation system according to claim 7, wherein the learner updates the estimation model by performing an additional learning to the estimation model by the machine learning for the section where the accuracy determiner specified that the accuracy is low.

9. The estimation system according to claim 7, wherein the learner newly creates the estimation model by relearning by the machine learning for the section where the accuracy was specified as low by the accuracy determiner from the correspondence relationship between the first input data and the first output data and the correspondence relationship between a new input data and an actual value corresponding to the new input data.

10. The estimation system according to claim 7, comprising an accuracy storage that associates and stores the second estimation value which was determined to have high accuracy by the accuracy determiner and a time at which the estimator had performed said estimation,
wherein the precision estimator obtains the second estimation value which was determined to have high accuracy and which is the closest to the time of estimation from the accuracy storage, replaces the second estimation value which was determined to have low accuracy with the obtained second estimation value, and outputs the obtained second estimation value to the user interface.

11. The estimation method comprising:
a learning process of creating an estimation model by machine learning from a correspondence relationship between a first input data and a first output data;
an estimating process of estimating an output value obtained by inputting a second output data to the estimation model as a second estimation value which is an output value corresponding to the second input data;
a precision estimation information creating process of creating a precision estimation information which is a correspondence relationship between the first estimation value obtained by inputting the first input data to the estimation model and an accuracy reference information for the first estimation value;
a precision estimating process of acquiring the accuracy reference information for the second estimation value based on the second estimation value and the precision estimation information and acquiring an accuracy information for the second estimation value by outputting the accuracy reference information as the accuracy information that is an estimation precision of the second estimation value; and
an outputting process of outputting the second estimation value obtained by the estimating process and the accuracy information for the second estimation value obtained by the precision estimating process.

12. The estimation program that makes the computer to execute:
a learning process of creating an estimation model by machine learning from a correspondence relationship between a first input data and a first output data;
an estimating process of estimating an output value obtained by inputting a second output data to the estimation model as a second estimation value which is an output value corresponding to the second input data;
a precision estimation information creating process of creating a precision estimation information which is a correspondence relationship between the first estimation value obtained by inputting the first input data to the estimation model and an accuracy reference information for the first estimation value;
a precision estimating process of acquiring the accuracy reference information for the second estimation value based on the second estimation value and the precision estimation information and acquiring an accuracy information for the second estimation value by outputting the accuracy reference information as the accuracy information that is an estimation precision of the second estimation value; and
an outputting process of outputting the second estimation value obtained by the estimating process and the accuracy information for the second estimation value obtained by the precision estimating process.

13. The estimation system according to claim 2, comprising a user interface that outputs the estimation value obtained by the estimator and the accuracy information for the second estimation value obtained by the precision estimator.

14. The estimation system according to claim 3, comprising a user interface that outputs the estimation value obtained by the estimator and the accuracy information for the second estimation value obtained by the precision estimator.

15. The estimation system according to claim 4, comprising a user interface that outputs the estimation value obtained by the estimator and the accuracy information for the second estimation value obtained by the precision estimator.

16. The estimation system according to claim 6, comprising an accuracy determiner provides a threshold for the accuracy information and determines whether the accuracy is lower than the threshold or not.
